(19) United States
(12) Patent Application Publication
(10) Pub. No.: US 2013/0222354 A1
(43) Pub. Date: Aug. 29, 2013

(54) Adjustment of Display Brightness

(71) Applicant: Rami Arto Koivunen, Turku (FI)

(72) Inventor: Rami Arto Koivunen, Turku (FI)

(73) Assignee: Nokia Corporation, Espoo (FI)

(21) Appl. No.: 13/824,431

(22) PCT Filed: Sep. 17, 2010
(86) PCT No.: PCT/FI10/50719

§ 371 Date: May 6, 2013

(51) Int. Cl. G09G 5/10

(52) U.S. Cl. CPC G09G 5/10
USPC 345/207

(57) ABSTRACT

An apparatus including a display with a plurality of pixels, the pixels being configured to display data in co-operation with lighting of the pixels; and a plurality of ambient light sensors. Output of the ambient light sensors is configured to cause adjustment of amount of lighting for individual pixel groups of the display in response to amount of ambient light detected by the ambient light sensors. Each pixel group includes at least one pixel.

### TECHNICAL FIELD

The present invention generally relates to display brightness and especially, but not exclusively, to adjustment of display brightness in foldable displays.

### BACKGROUND ART

A liquid crystal display (LCD) is a display that uses light modulating properties of liquid crystals (LCs). The display comprises number of pixels filled with liquid crystals. Commonly the pixels need to be backlit in order to be easily visible. The amount of backlight may be adjusted based on external lighting conditions.

### SUMMARY

According to a first example aspect of the invention there is provided an apparatus comprising:
a display comprising a plurality of pixels, the pixels being configured to display data in co-operation with lighting of the pixels; and
a plurality of ambient light sensors, wherein
output of the ambient light sensors is configured to cause adjustment of amount of lighting for individual pixel groups of the display in response to amount of ambient light detected by the ambient light sensors, and wherein each pixel group comprises at least one pixel.

According to a second example aspect of the invention there is provided a method comprising:
detecting amount of ambient light falling on a display, which comprises a plurality of pixels configured to display data in co-operation with lighting of the pixels; and
adjusting the amount of lighting for individual pixel groups of the display in response to the amount of ambient light detected, wherein each pixel group comprises at least one pixel.

According to a third example aspect of the invention there is provided an apparatus comprising:
means for detecting amount of ambient light falling on a display, which comprises a plurality of pixels configured to display data in co-operation with lighting of the pixels; and
means for adjusting the amount of lighting for individual pixel groups of the display in response to the amount of ambient light detected, wherein each pixel group comprises at least one pixel.

According to a fourth example aspect of the invention there is provided a computer program comprising computer executable program code configured to cause an apparatus, when executed, to perform the method according to the second example aspect.

According to a fifth example aspect of the invention there is provided a computer readable memory medium comprising the computer program of the fourth example aspect.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

Some example embodiments of the invention will be described with reference to the accompanying drawings, in which:

FIGS. 1-4 show block diagrams of a display unit according to some embodiments of the invention;

FIG. 5 shows a block diagram of an apparatus according to an embodiment of the invention;

FIGS. 6-8 show illustrations of displays according to some embodiments of the invention; and

FIG. 9 shows a flow chart illustrating a process according to an embodiment of the invention.

### DETAILED DESCRIPTION

An embodiment of the invention provides independent adjustment of amount of lighting (e.g. backlight) at different areas of a display in contrast to prior art solutions in which even lightning over the whole display area is commonly used. In this way one may achieve even contrast even in varying ambient light conditions instead of even backlight or brightness.

In an embodiment of the invention the amount of lighting is dynamically adjusted based in ambient light falling on different parts of the display.

In an embodiment of the invention a display comprises a plurality of ambient light sensors. Outputs of the ambient light sensors are configured to cause adjustment of amount of lighting falling on individual pixels or pixel groups of a display in response to the amount of ambient light detected by the ambient light sensors.

Especially when a display can be deformed (bent or folded), the ambient light conditions over the display area may be uneven. Some areas may get more direct light than others (e.g. sun light coming from certain direction). In that case lighting or brightness configured to suit for ambient light conditions on certain area of the display may result in that some parts of the display are lit up too brightly and/or some not brightly enough. By adjusting the amount of lighting for individual pixels or pixel groups based on ambient light conditions detected near the pixel/pixel group, one may achieve a display that appears to have even brightness even if the display is not evenly lit by the ambient light.

In an embodiment of the invention, the adjustment is configured to be performed independently for different pixel groups. Herein a pixel group comprises one or more pixels. The amount of lighting for a pixel group may be adjusted based on output of one ambient light sensor or based on output of more than one ambient light sensor. Also backlight/lighting conditions and/or ambient light conditions affecting nearby pixels may be taken into account when adjusting the amount of lighting for a certain pixel (or pixel group).

In an embodiment of the invention, outputs of the ambient light sensors are fed into a controller, which adjusts the amount of lighting responsive to the outputs. There may be one controller that receives all outputs and performs all controlling or there may be more than one controller. In an example, there is one controller or control unit for each sensor or for each pixel/pixel group.

In an embodiment of the invention, the outputs of the ambient light sensors have a hardwired connection to a plurality of light sources that provide backlight for the display. That is, the outputs of the ambient light sensors may be directly connected to the plurality of light sources and a separate controller is not needed.

In an embodiment of the invention, said lighting that is adjusted is backlight configured to light said pixels.

In an embodiment of the invention, the lighting that is adjusted is light emitted by said pixels.

In an embodiment of the invention, output of an ambient light sensor is directly coupled with the respective pixel and the output is configured to automatically adjust brightness of the pixel based on the ambient light conditions. In this case there is no separate backlight, but the pixels themselves emit the light that is needed for displaying data. In an example, display brightness is directly controlled by varying intensity of light emitted by light emitting diodes (LED) of a display. One could say that the backlight is sort of part of the pixel itself or that the pixel itself provides the needed lighting.

In an embodiment of the invention, the amount of lighting is adjusted responsive to content displayed on the display.

In an embodiment of the invention, the amount of lighting is adjusted by controlling the amount of light emitted by backlight sources included in the display.

In an embodiment of the invention, the amount of lighting is adjusted by selectively blocking part of available lighting from falling onto the pixels of the display. The blocking may be implemented in the form of shading or a panel or film having adjustable holes or adjustable transparency, for example.

In an embodiment of the invention, the ambient light sensors are arranged in a matrix or a grid. The matrix may be of any suitable form, such as for example a rectangle, a circle, a straight line, a random configuration, or an ordered row/line configuration. The sensors may be integrated into the display. For example, each pixel or every other pixel may comprise a sensor. Also other configurations are possible.

In an embodiment of the invention, the display is a bendable or foldable display.

In an embodiment of the invention, the display is a liquid crystal display, a light emitting diode display, an organic light emitting diode display, or a plasma display.

In an embodiment of the invention, the ambient light sensors are photosensitive diodes and/or photosensitive transistors.

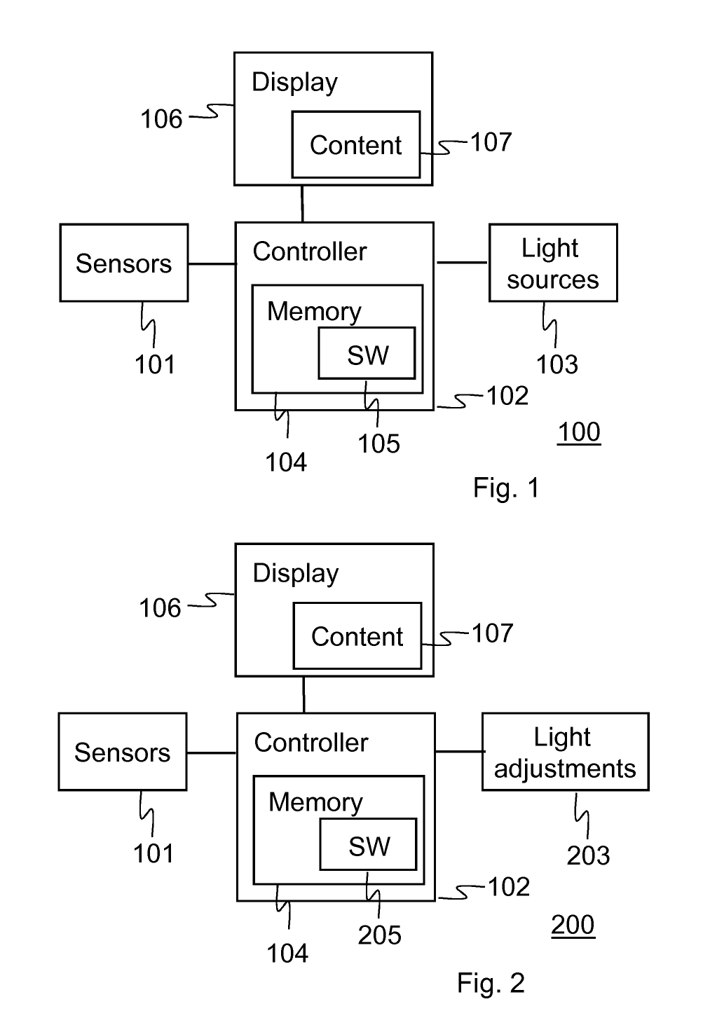

FIG. 1 shows a block diagram of a display unit 100 according to an embodiment of the invention. The display unit 100 comprises ambient light sensors 101, backlight sources 103, a controller 102 and a display 106. The display is configured to display content 107. The controller comprises a memory 104 and computer executable software 105 stored in the memory 104 and operable to executed by the controller 104.

The controller 102 may be, for instance, a control unit (MCU), a microprocessor, a digital signal processor (DSP), an application specific integrated circuit (ASIC), a field programmable gate array, a microcontroller or a combination of such elements. The controller may serve also other purposes than those disclosed herein.

The memory 104 may comprise for example any of a volatile memory, a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The controller 102 may comprise a plurality of memories. The memory 104 may be constructed as a part of the controller 102 or as a separate component. The memory 104 may serve the sole purpose of storing data, or it may be constructed as a part of a controller 102 serving other purposes, such as processing data.

The backlight sources 103 are configured to provide backlight that falls on pixels of the display 106.

In an embodiment of the invention, the software 105 causes the controller 102 to control the amount of light emitted by the backlight sources 103 in response to output from the ambient light sensors 101.

In an embodiment of the invention, the software 105 causes the controller 102 to control the amount of light emitted by the backlight sources 103 in response to output from the ambient light sensors 101 and the content 107 displayed on the display 106.

FIG. 2 shows a block diagram of a display unit 200 according to an embodiment of the invention. The display unit 200 comprises ambient light sensors 101, backlight adjustment equipment 203, a controller 102 and a display 106. The display is configured to display content 107. The controller comprises a memory 104 and computer executable software 205 stored in the memory 104 and operable to executed by the controller 104.

In this example, the display unit 200 does not necessarily include own backlight sources. Instead the display 106 may be configured to use ambient light as the backlight source. It is however possible that the display unit 200 does include also own backlight sources.

The controller 102 may be, for instance, a control unit (MCU), a microprocessor, a digital signal processor (DSP), an application specific integrated circuit (ASIC), a field programmable gate array, a microcontroller or a combination of such elements. The controller may serve also other purposes than those disclosed herein.

The memory 104 may comprise for example any of a volatile memory, a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The controller 102 may comprise a plurality of memories. The memory 104 may be constructed as a part of the controller 102 or as a separate component. The memory 104 may serve the sole purpose of storing data, or it may be constructed as a part of a controller 102 serving other purposes, such as processing data.

In an embodiment of the invention, the software 205 causes the controller 102 to control the backlight adjustment equipment 203 to selectively block part of available backlight from falling onto the pixels of the display 106 in response to output from the ambient light sensors 101.

In an embodiment of the invention, the software 205 causes the controller 102 to control the backlight adjustment equipment 203 to selectively block part of available backlight from falling onto the pixels of the display 106 in response to output from the ambient light sensors 101 and the content 107 displayed on the display 106.

It must be appreciated that FIGS. 1 and 2 show only example implementations and that various changes to the shown structure are possible. For example, there may be a separate controller controlling the content shown in the display and another one controlling the amount of backlight. That is, the connection between the display 106 and the controller 102 is not mandatory. In case the controller 102 is not connected to the display, information about the content that is displayed on the display may be provided to the controller 102 from some other source.

In an embodiment of the invention, the controller 102 of FIG. 1 or 2 may be configured to control pixels of the display 106 and the amount of light emitted by the pixels in response to output from the ambient light sensors 101.

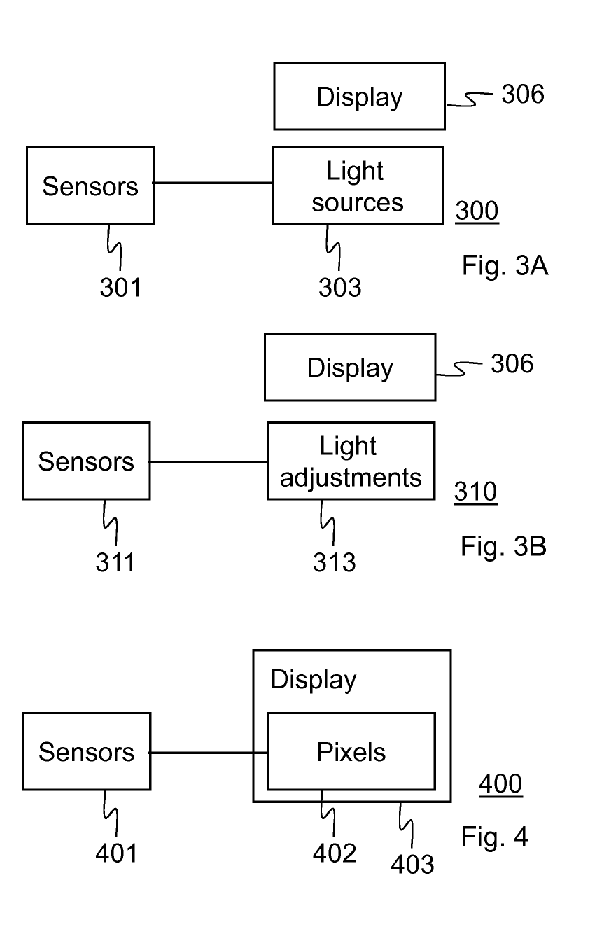

FIG. 3A shows a block diagram of a display unit 300 according to an embodiment of the invention. The display unit 300 comprises ambient light sensors 301, backlight sources 303, and a display 306. The backlight sources 303 are configured to provide backlight that falls on pixels of the display 306.

In this example, the ambient light sensors 301 are directly connected to the backlight sources 303. The output of the ambient light sensors 301 is configured to control the amount of light emitted by the backlight sources 303. In practice, the backlight sources 303 may be configured to adapt the amount of light they emit based on output from the ambient light sensors 301 or the ambient light sensors 301 may be configured to provide output suitable for controlling the amount of light emitted by the backlight sources 303.

FIG. 3B shows a block diagram of a display unit 310 according to an embodiment of the invention. The display unit 310 comprises ambient light sensors 311, backlight adjustment equipment 313, and a display 306.

In this example, the display unit 310 does not necessarily include own backlight sources. Instead the display 306 may be configured to use ambient light as the backlight source. It is however possible that the display unit 310 does include also own backlight sources.

In this example, the ambient light sensors 311 are directly connected to the backlight adjustment equipment 313. The output of the ambient light sensors 311 is configured to control the backlight adjustment equipment 313 to selectively block part of available backlight from falling onto the pixels of the display 306. In practice, the backlight adjustment equipment 313 may be configured to adapt the amount of light they block based on output from the ambient light sensors 311 or the ambient light sensors 311 may be configured to provide output suitable for controlling the amount of light blocked by the backlight adjustment equipment 313.

FIG. 4 shows a block diagram of a display unit 400 according to an embodiment of the invention. The display unit 400 comprises ambient light sensors 401, display 403 and pixels 402 of the display. The output of the ambient light sensors 401 is configured to control the amount of light emitted by the pixels 403 of the display 402.

It must be noted that FIGS. 3A, 3B and 4 discuss sensors, light sources, light adjustments and pixels in plural form, but only one connection between different elements is shown for clarity. The actual connection may be different in different embodiments of the invention. For example, each sensor may be connected to single one light source, light adjustment equipment or pixel or each sensor may be connected to more than one light source, light adjustment equipment or pixel. Likewise each light source, light adjustment equipment or pixel may be connected to single one sensor or each light source, light adjustment equipment or pixel may be connected to more than one sensor.

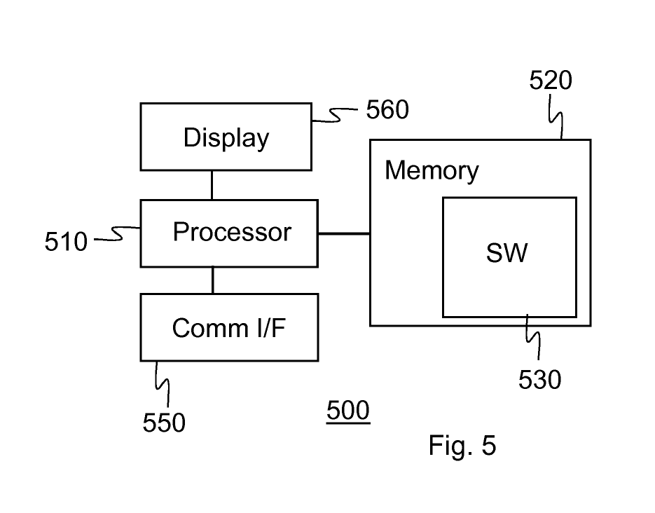

FIG. 5 shows a block diagram of an apparatus 500 according to an embodiment of the invention. The apparatus may be any suitable electronic apparatus that comprises a display, such as a mobile communication device, a smart phone, a tablet computer, a laptop computer, or other electronic device.

The apparatus 500 may comprise a communication interface 550. Further, the apparatus comprises a processor 510 communicatively connected to the communication interface 550 (if present), a memory 520 communicatively connected to the processor 510, and computer executable software 530 stored in the memory 520 and operable to executed by the processor 510. The apparatus 500 further comprises a display unit 560 communicatively connected to the processor 510.

The display unit 560 may be for example a display unit shown in one of FIGS. 1-4.

The communication interface 550 may comprise, for instance, a radio interface such as a wireless local area network (WLAN), Bluetooth, GSM/GPRS, CDMA, WCDMA, or LTE (Long Term Evolution) radio interface. Alternatively or additionally, the communication interface 550 may comprise a fixed communication connection port such as a local area network connector, universal serial bus connector, RS-232 connector, or IEEE-1394 connector (i.e. firewire® connector). The communication interface module 550 may be integrated into the control unit 500 or into an adapter, card or the like that may be inserted into a suitable slot or port of the control unit 500. Moreover, or alternatively, the communication interface module 550 may support one radio interface technology or a plurality of technologies.

The processor 510 may be, for instance, control unit (MCU). Alternatively, the processor may be a microprocessor, a digital signal processor (DSP), an application specific integrated circuit (ASIC), a field programmable gate array, a microcontroller or a combination of such elements.

The memory 520 may comprise for example any of a volatile memory, a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The control unit 200 may comprise a plurality of memories. The memory 520 may be constructed as a part of the apparatus 500 or it may be inserted into a slot, port, or the like of the apparatus 500 by a user. The memory 520 may serve the sole purpose of storing data, or it may be constructed as a part of the apparatus serving other purposes, such as processing data.

A skilled person appreciates that in addition to the elements shown in FIGS. 1-5, the display units 100, 200, 300, 310, 400 and the apparatus 500 may comprise other elements, such as microphones as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the display units 100, 200, 300, 310, 400 and the apparatus 500 may comprise a disposable or rechargeable battery (not shown) for powering the display unit or the apparatus if external power supply is not available.

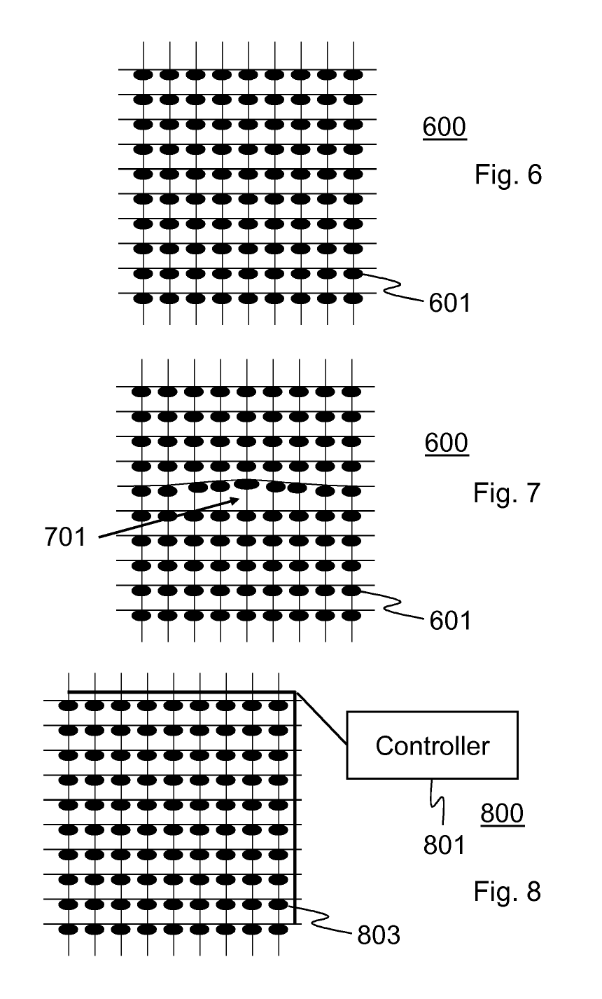

FIGS. 6 and 7 show an illustration of a display 600 according to an embodiment of the invention. The display 600 comprises a plurality of ambient light sensors 601 arranged in a matrix or a grid. The sensors may be integrated into the display 600. There may be for example one sensor for each pixel of the display 600, or one sensor per four pixels, or one sensor per some other amount of pixels. In any case, there are more than one sensor. The display is a bendable or a foldable display and the display may be for example an LCD display.

FIG. 6 shows the display 600 in straight, unbent state. In this case the sensors are evenly distributed. FIG. 7 shows area 701 in which the display 600 is bent or stretched. For example, a user of the display 600 may push the display 600 with a finger at area 701. The surface contour of the display has changed and is different form the one shown in FIG. 6. Therefore shadows and/or lighting conditions affecting different parts of the display may vary.

FIG. 8 shows an illustration of a display 800 according to an embodiment of the invention. The display 800 comprises a plurality of ambient light sensors 803 arranged in a matrix or a grid. The sensors may be integrated into the display 800.

Output of each ambient light sensor 803 is connected to a controller 801.

In an embodiment of the invention , the controller 801 receives out signals of the ambient light sensors 803. The controller 801 may for example scan the outputs of the sensors 803. The controller 801 then determines the amount of lighting needed around each sensor 803 on the basis of these outputs. The controller 801 may determine the amount of lighting for a small group of pixels (one or more) at a time or individually for each pixel of the display 800.

In an example implementation, the controller 801
1. Scans in first row (1 . . . N) of ambient light sensor output values.
2. Scales the amount of backlight in the display around 1. ambient light sensor according to the 1. ambient light sensor value.
3. Scales the amount of backlight in the display around 2. ambient light sensor according to the 2. ambient light sensor value
4. Scales the amount of backlight in the display around N. ambient light sensor according to the N. ambient light sensor value
5. Scans in second row (1 . . . N) of ambient light sensor output values. And so on for all rows/columns in the display.

The controller 801 may go through scaling the amount of lighting for the whole display first and cause the corresponding adjustment of lighting thereafter, or the controller 801 may cause adjustment of lighting in real time at the same time when the sensor output values are scanned in. Additionally or alternatively, the controller may continuously scan the output values or the scanning may be performed at certain intervals.

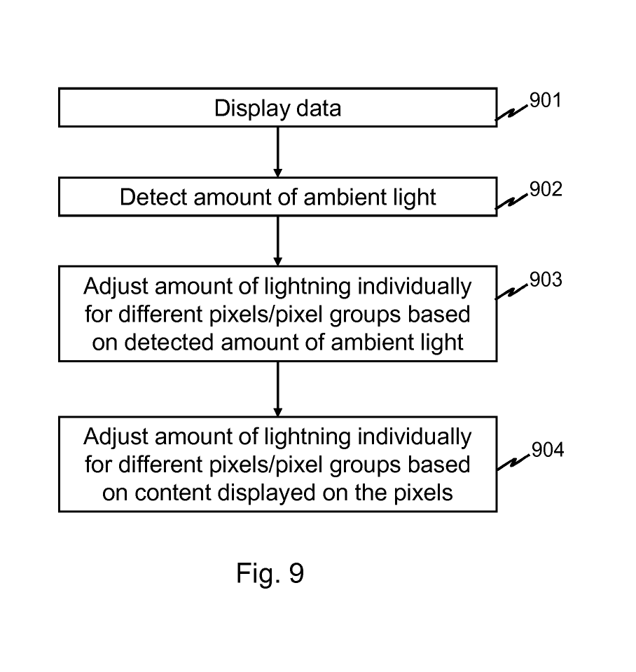

FIG. 9 shows a flow chart illustrating a process 900 according to an embodiment of the invention. The method may be performed for example in the display units of FIGS. 1-4 and more specifically in the controllers 102 and 801.

In phase 901, data is displayed on pixels of a display. In phase 902, amount of ambient light falling on the display is detected. In phase 903, amount of lighting (e.g. backlight) is adjusted individually for different pixels/pixel groups based on the detected amount of ambient light. The adjustment may be performed by controlling the amount of light emitted by light sources providing backlight for the display or by selectively blocking part of available backlight from falling onto the pixels or by controlling the amount of light emitted by individual pixels. In phase 904, amount of lighting (e.g. backlight) is adjusted individually for different pixels/pixel groups based on content displayed on the pixels.

It should be appreciated that it is not mandatory to perform all phases shown in FIG. 9 or that the phases may be performed in different order. Additionally, for example phases 903 and 904 may be combined so that they are performed simultaneously.

When the amount of lighting is adjusted individually for pixels or (small) pixel groups based on ambient light conditions at respective pixel or pixel group, it may be possible to achieve a display that appears to be evenly lit even when the display is foldable and/or is exposed to uneven ambient light. That is, the display is not necessarily evenly lit, but the relationship between ambient light and display lighting is even over the display area. In this way user experience associated with for example LCD displays may be improved.

Additionally, by adjusting the amount of lighting individually for pixels or (small) pixel groups, it may be possible to conserve energy as some parts of the display may be dimmer than other depending on external lighting conditions. This may be achieved without deteriorating the viewing experience.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An apparatus comprising:
a display comprising a plurality of pixels, the pixels being configured to display data in co-operation with lighting of the pixels; and
a plurality of ambient light sensors, wherein
output of the ambient light sensors is configured to cause adjustment of amount of lighting for individual pixel groups of the display in response to amount of ambient light detected by the ambient light sensors, and wherein each pixel group comprises at least one pixel.

2. The apparatus of claim 1, wherein said adjustment is configured to be performed independently for different pixel groups.

3. The apparatus of claim 1, further comprising a controller configured to receive the outputs of one or more ambient light sensors and to adjust the amount of lighting for one or more pixel groups responsive to said one or more outputs of the ambient light sensors.

4. The apparatus of claim 3, wherein said controller is further configured to adjust the amount of lighting responsive to content displayed on the pixels of the display.

5. The apparatus of claim 3, wherein said controller is further configured to adjust the amount of lighting for a pixel group based on output of one ambient light sensor.

6. The apparatus of claim 3, wherein said controller is further configured to adjust the amount of lighting for a pixel group based on outputs of more than one ambient light sensor.

7. The apparatus of claim 1, further comprising a plurality of light sources, wherein said adjustment of the amount of lighting is configured to be caused by controlling the amount of light emitted by said light sources.

8. The apparatus of claim 7, wherein the plurality of ambient light sensors have a hardwired connection to the plurality of light sources.

9. The apparatus of claim 1, further comprising adjustment equipment configured to selectively block part of available lighting from falling onto the pixels, wherein said adjustment of the amount of lighting is configured to be caused by controlling the amount of said blocking.

10. The apparatus of claim 1, wherein said plurality of ambient light sensors is arranged in a matrix.

11. The apparatus of claim 1, wherein said lighting is backlight configured to light said pixels.

12. The apparatus of claim 1, wherein said lighting is light emitted by said pixels.

13. The apparatus of claim 1, wherein the display is a bendable display.

14. (canceled)

15. The apparatus of claim 1, wherein the apparatus is a mobile communication device.

16. A method comprising:
detecting amount of ambient light falling on a display, which comprises a plurality of pixels configured to display data in co-operation with lighting of the pixels; and
adjusting the amount of lighting for individual pixel groups of the display in response to the amount of ambient light detected, wherein each pixel group comprises at least one pixel.

17. The method of claim 16, further comprising performing said adjusting independently for different pixel groups.

18. The method of claim 16, further comprising adjusting the amount of lighting responsive to content displayed on the pixels of the display.

19. The method of claim 16, further comprising performing said adjusting by controlling the amount of light emitted by light sources.

20. The method of claim 16, further comprising performing said adjusting by selectively blocking part of available lighting from falling onto the pixels.

21. (canceled)

22. A computer readable memory medium comprising computer executable program code configured, when executed by an apparatus, to cause the apparatus to perform:
detecting amount of ambient light falling on a display, which comprises a plurality of pixels configured to display data in co-operation with lighting of the pixels; and
adjusting the amount of lighting for individual pixel groups of the display in response to the amount of ambient light detected, wherein each pixel group comprises at least one pixel.
